(19) United States
(12) Patent Application Publication
(10) Pub. No.: US 2022/0137594 A1
(43) Pub. Date: May 5, 2022

(54) CNC-PARAMETER GENERATING METHOD FOR AN AUTOMATED TUBE BENDING SYSTEM

(71) Applicant: Vetco Gray Scandinavia AS, Nailsea (GB)

(72) Inventor: Lars Erik WIK, Stord (NL)

(21) Appl. No.: 17/310,791

(22) PCT Filed: Feb. 25, 2020
(86) PCT No.: PCT/EP2020/025092

§ 371 Date: Aug. 24, 2021

(30) Foreign Application Priority Data
Feb. 26, 2019 (NO) 20190267

(51) Int. Cl. G05B 19/4093; B21D 7/12; G05B 19/4097

(52) U.S. Cl. CPC G05B 19/40932; B21D 7/12; G05B 19/4097; G05B 2219/45143; G05B 2219/36203; G05B 2219/35192; G05B 2219/36312

(57) ABSTRACT

The present invention provides a CNC-parameter generating method in an isometric projection environment for the control and processing of tubes by at least one CNC-tube bending machine at least comprising: i) to generate a first vector on a touch screen; ii) to carry out a verification step by a microprocessor, iii) to assign the first vector to one of the directions, NORTH, UP, WEST, SOUTH, DOWN and EAST; iv) to generate further vectors by tapping once on the touch screen; v) to input dimensional values for the vectors on the touch screen, and to transfer dimensional values from the microprocessor device to one or more computers. It is also provided a parameter generating system in an isometric projection environment for the control and processing of tubes by at least one CNC-tube bending machine.

### TECHNICAL FIELD

The present invention relates to an automated tube bending system, and more particularly to a CNC-parameter generating method in an isometric projection environment and to a CNC-parameter generating system in an isometric projection environment for the control and processing of tubes by at least one CNC-tube bending machine.

### BACKGROUND ART

Automated tube bending machines such as CNC tube bending machines are numerically controlled by computers. In prior art solutions, an operator has to sketch the tubing path by hand, do any calculations needed and then manually plot the coordinates in to a CNC tube-bending machine. FIG. 1 illustrates the traditional way of sketching a path for a piece of tubing. The traditional way representing the pen and paper is both time consuming and a bad idea when it comes to documentation control. Unlike orthographic, piping isometrics, allow the pipe to be drawn in a manner by which the length, width and depth are shown in a single view. Isometrics are usually drawn from information found on a plan and elevation views. Usually, piping isometrics are drawn on pre-printed paper, with lines of equilateral triangles of 60°.

WO 2018/054431 A1 discloses a method for controlling a tube bending machine with a communication unit. Bending parameters are numerically entered into the communication unit, the entered parameters are then communicated to a tube bending machine.

One object of the present invention is to reduce the time consuming step of manual sketching paths and bends for tubes.

Another object of the invention is to provide a method for production of CNC parameters in an isometric projection environment for tube bending.

### DISCLOSURE OF THE INVENTION

According to the present invention it is provided a CNC-parameter generating method in an isometric projection environment for the control and processing of tubes by at least one CNC-tube bending machine at least comprising:
a) to generate a first vector on a touch screen by tapping twice on the touch screen, the touch screen being in communication with a microprocessor device;
b) to carry out a verification step by the microprocessor, is the absolute value, length, of the first vector greater than a threshold value, Tₕ, if not continue with step a);
c) to assign the first vector to one of the six directions, NORTH, UP, WEST, SOUTH, DOWN and EAST;
d) is the vector assignment correct, if no continue with step a);
e) to generate further vectors by tapping once on the touch screen;
f) to input dimensional values for the vectors on the touch screen, and
g) to transfer dimensional values from the microprocessor device to one or more computers, where the one or more computers are in communication with one or more CNC-tube bending machines.

Step a) above may further comprise the steps of:
ai) tapping a first input location parameter on the touch screen, the touch screen being in communication with the microprocessor device,
aii) verifying correctness of the first input location parameter,
   i. if the first input parameter does not fit correctly in a set isometric grid pattern continue at point ai),
aiii) is the first input location parameter a first point, if no continue at av),
aiv) set the first input location parameter as the first point, and set last point equal with first point, continue at point ai);
av) create a vector between the first input location parameter and a last point.

Step b) above may at least comprise:
bi) is the difference between the absolute value of the first input location parameter and the first point greater than a threshold value, Tₕ, the difference represents a first vector, if the difference is not greater than Tₕ, then continue at point ai).

The vector assignment step c) may at least comprise:
ci) decide UP or DOWN orientation of vector:
   if the Y-component is less than zero then continue at i);
      if the Y-component is greater than zero then continue at ciii);
         i. decide if vector Y-component is UP, if vector Y-component is UP then set vector Y-component UP and continue at vi);
cii) decide WEST or NORTH orientation of vector:
   ii. decide if vector X-component is WEST, if vector X-component is WEST then then set vector X-component WEST and continue at vi);
   iii. set vector Z-component to NORTH, and continue at vi)
ciii) decide if vector Y-component is DOWN, if vector Y-component is DOWN then then set vector Y-component DOWN and continue at vi);
civ) decide EAST or SOUTH orientation of vector:
   iv. decide if vector X-component is EAST, if vector X-component is EAST then set vector X-component to EAST and continue at vi);
   v. set vector Z-component to SOUTH;
   vi. carry out a self crash test, is the vector orientation opposite of last direction, if the vector orientation is opposite then the next step will be to generate a first vector by inputting parameters on a touch screen, the touch screen being in communication with a microprocessor device.

The method above regarding the assignment step may further comprise the substeps of:
ia) carrying out vector component angle measurement;
   is vector component angle greater than α, if no then continue with substep ib);
   is vector component angle less than β, if no then continue with substep ib), else continue with substep ic);
ib) is vector component angle greater than −β, if no then continue with substep id);
   is vector component angle less than α, if no then continue with substep id)
ic) set vector component angle to ABS β and set vector Y-component UP;
id) if vector Y-component is UP then carry out a self crash test else decide if vector component is WEST or NORTH. The substep id) may at least comprise the further substeps of:

carrying out a WEST or NORTH test:
is vector component angle less than or equal to α, if no then continue with substep ie);
is vector component angle greater than or equal to γ, if no then continue with substep ie);
set vector component angle to ABS δ and set vector component WEST;
ie) if vector component is WEST then carry out a self crash test else set vector component angle to ABS δ and set vector component to NORTH then carry out a self crash test.

The substep ciii) above may at least comprise the further substeps of:
ia) carrying out vector component angle measurement;
is vector component angle greater than α, if no then continue with substep ib);
is vector component angle less than β, if no then continue with substep ib), else continue with substep ic);
ib) is vector component angle greater than −β, if no then continue with substep id);
is vector component angle less than α, if no then continue with substep id)
ic) set vector component angle to ABS β and set vector Y-component DOWN;
id) if vector Y-component is DOWN then carry out a self crash test else decide if vector component is EAST or SOUTH.

Substep id) above may at least comprises the further substeps of:

carrying out a EAST or SOUTH test:
is vector component angle less than or equal to α, if no then continue with substep ie);
is vector component angle greater than or equal to γ, if no then continue with substep ie);
set vector component angle to ABS δ and set vector component EAST;
ie) if vector component is WEST then carry out a self crash test else set vector component angle to ABS δ and set vector component to SOUTH then carry out a self crash test.

The vector assignment step c) above may at least comprise the steps of:
c1) to set origin Y=0 and X=0 to upper left corner of the touch screen;
c2) to create a horizontal reference vector for measurement of first vector component angles;
c3) to carry out a first vector component angle test for assignment of one of the directions: NORTH, UP, WEST, SOUTH, DOWN and EAST. The vector component angle test c3) may at least comprise the steps of:
to carry out one or more of the six tests:
   i. is vector component angle, vca, greater than or equal to γ and smaller than α, if yes then set vca=δ and continue at vii;
   ii. is ε>vca≥α, if yes then set vca=β and continue at vii;
   iii. is θ>vca≥ε, if yes then set vca=ζ and continue at vii;
   iv. is λ>vca≥θ, if yes then set vca=κ and continue at vii;
   v. is ρ>vca≥λ, if yes then set vca=ξ and continue at vii;
   vi. is γ>vca≥ρ, if yes then set vca=σ and continue at vii;
   vii. continue with step d in claim 1.

In another aspect the vector component angle test c3) may at least comprise the steps below where

$${tan}^{- 1} \vert \frac{Y}{X} \vert :$$

to carry out one or more of the six tests:
   i. is γ≤vcaᵢₙₜ≤α and Y<0 and X>0 then set vca=δ, and continue at vii;
   ii. is γ≤vcaᵢₙₜ≤α and Y<0 and X<0 then set vca=ξ, and continue at vii;
   iii. is γ≤vcaᵢₙₜ≤α and Y>0 and X<0 then set vca=κ, and continue at vii;
   iv. is γ≤vcaᵢₙₜ≤α then set vca=α, and continue at vii
   v. is α<vcaᵢₙₜ<β and Y<0 then set vca=β and continue at vii;
   vi. is α<vcaᵢₙₜ<β and Y>0 then set vca=ξ;
   vii. continue with step d in claim 1.

In another aspect the vector component angle test c3) may at least comprise the steps below where

$${vca}_{int} = {tan}^{- 1} \frac{Y}{X} :$$

to carry out one or more of the eight tests:
   i. is γ≤vcaᵢₙₜ<α and Y<0 and X>0 then set vca=δ, and continue at ix;
   ii. is γ≤vcaᵢₙₜ<α and Y>0 and X<0 then set vca=κ, and continue at ix;
   iii. is −α≤vcaᵢₙₜ<γ and Y>0 and X>0 then set vca=α, and continue at ix;
   iv. is −α≤vcaᵢₙₜ<γ and Y<0 and X<0 then set vca=ξ, and continue at ix;
   v. is α≤vcaᵢₙₜ<β and Y<0 then set vca=β and continue at ix;
   vi. is α≤vcaᵢₙₜ<β and Y>0 then set vca=ξ and continue at ix;
   vii. is −β<vcaᵢₙₜ<α and Y<0 then set vca=β and continue at ix;
   viii. is −β<vcaᵢₙₜ<α and Y>0 then set vca=ξ;
   ix. continue with step d in claim 1.

In one aspect of the invention step e) above at least comprises the sub steps:
e1) testing if input parameter is a tap or press, if the input is press then an intermediate helpline is drawn,
e2) drawing a vector line from beginning of first helpline to end of a second helpline, and continue to wait for input parameters.

According to the present invention it is also provided a CNC-parameter generating system in an isometric projection environment for the control and processing of tubes by at least one CNC-tube bending machine at least comprising:
a) a first operator in operable communication with a portable device, the portable device comprises:
   a1) an input unit;
   a2) a software program for CNC-parameter generation in operable communication with the input device;
   a3) a display unit in operable communication with the software program configured to display parameters generated by the software program on an isometric pattern including;
b) a communication interface facilitating communication between the portable device and at least a first computer, and
c) a communication interface facilitating communication between the first computer and at least a first CNC tube bending machine.

The CNC-parameter generating system may additionally comprise:
d) a second computer in operable communication with the portable device, the second computer being configured to compile tube bending parameters from the portable device into a format independent of the software program, and/or
e) a tubing spool for loading into the CNC tube bending machine.

Further features of the present invention appears form the appended claims.

### BRIEF DESCRIPTION OF DRAWINGS

Following is a brief description of the drawings in order to make the invention more readily understandable, the discussion that follows will refer to the accompanying drawings, in which

FIG. 1 illustrates sketching of a path for a piece of small bore tubing according to prior art;

FIG. 2 shows a system for production of CNC parameters in an isometric projection environment for tube bending;

FIG. 3a-3j shows a number of steps carried out on a portable device, each step shown as a separate screen dump;

FIG. 4 show 2D environment on a portable device—the isometric system on a portable device and a 3D—coordinate representation;

FIG. 5a and 5b shows examples of display screens on a portable device for creation of CSV-files with coordinates for support of a tube bending machine;

FIG. 6 shows a general float chart of a method for production of CNC parameters in an isometric projection environment for tube bending;

FIG. 7 shows a “unity circle” which is used as supportive illustration for understanding vector directions in an isometric system according to the present invention;

FIG. 8 shows a detailed float chart of a method for production of CNC parameters in an isometric projection environment for tube bending;

FIG. 9a-9d shows a conversion from isometric grid systems to a modified grid system;

FIG. 10 shows first quadrant of a unity circle where it is illustrated how a b vector will snap to β, whilst an a vector is closer to NORTH and will snap to NORTH;

FIG. 11a shows a function for single tap by an operator on a portable device, the function being a function in an alternative algorithm in an isometric projection environment, where on screen parameters on the portable device is converted to CNC parameters for tube bending;

FIG. 11b shows a sub algorithm for an alternative algorithm in an isometric projection environment, where on screen parameters on a portable device is converted to CNC parameters for tube bending, the sub algorithm describes how points on a screen is snapped to a grid in an isometric projection environment; and

FIG. 11c shows a sub algorithm for an alternative algorithm in an isometric projection environment, where on screen parameters on a portable device is converted to CNC parameters for tube bending, the sub algorithm is an algorithm for validation of vector directions on a screen is in an isometric projection environment.

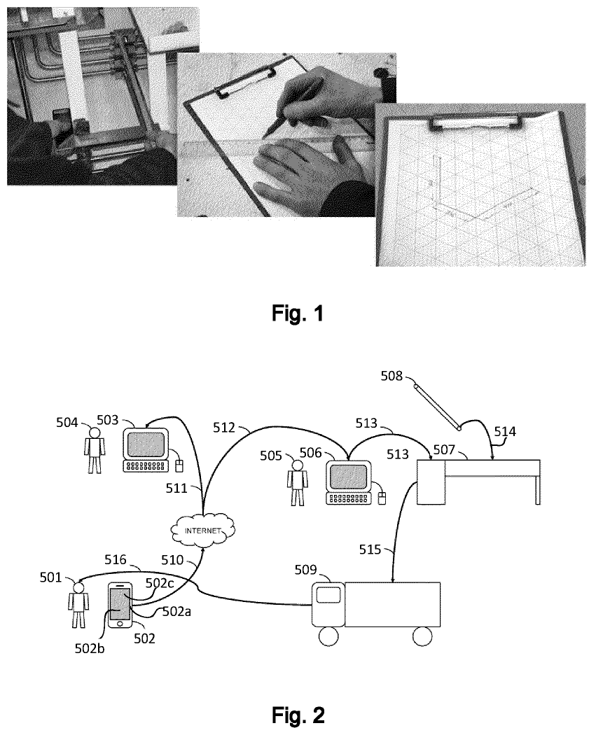

### MODE(S) FOR CARRYING OUT THE INVENTION

In the following it is firstly disclosed general embodiments in accordance to the present invention, thereafter, particular exemplary embodiments will be described. Where possible reference will be made to the accompanying drawings and where possible using reference numerals in the drawings. It shall be noted however that the drawings are exemplary embodiments only and other features and embodiments may well be within the scope of the invention as described.

In principle, the present invention relates to conversion of isometric draft charts for tubing or tube bending to CNC-machine readable formats. On-site observations are entered into isometric draft chart for tubing on a portable device. The isometric draft is then converted into “real scale model” and CNC (DAP) tubing parameters are prepared for CNC-bending machines.

The present invention provides a tool implemented on a portable device 502, such as a tablet or smart phone (FIG. 2). The portable device 502 shall at least have the capacity to execute a software routine according to the present invention. Moreover, the portable device must have communication capabilities thus facilitating sharing/transmission of data. The capability of wireless transmission between the portable device and a computer or a CNC-machine is advantageous. Tablet devices, proprietary portable devices or other generic portable devices that includes the necessary features can be used as a design tool for tube pathing and tube bending design according to the present invention. The tool is a software program 502a running on the portable device such as a smart device 502, the tool 502a provides a draft/sketching interface on a touch screen 502b on the portable device 502 or alternatively, the touch screen 502b can be in communication with the portable device 502. The draft/sketching interface is an isometric grid with lines of approximately equilateral triangles of 60°, a “grid” which deviates from the 60° regime will be described in a consecutive section. This grid layout is common for pre printed papers for drawing of tubing. The use of a software program 502a on a smart device opens up for other layouts with or without grids or dots. The software program 502a can be materialised as an app (application) for use on the smart device 502.

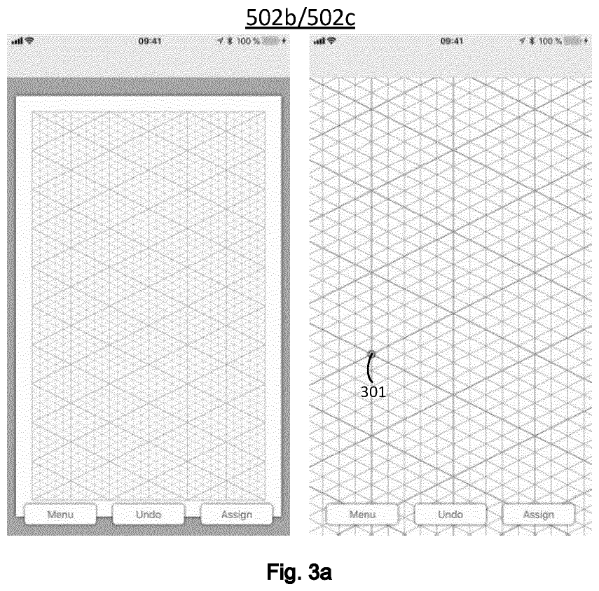

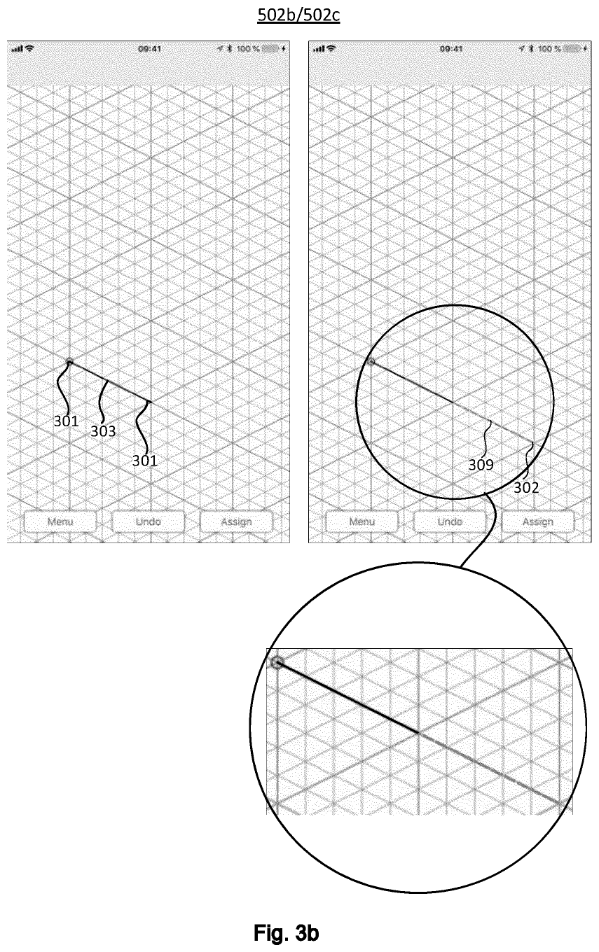

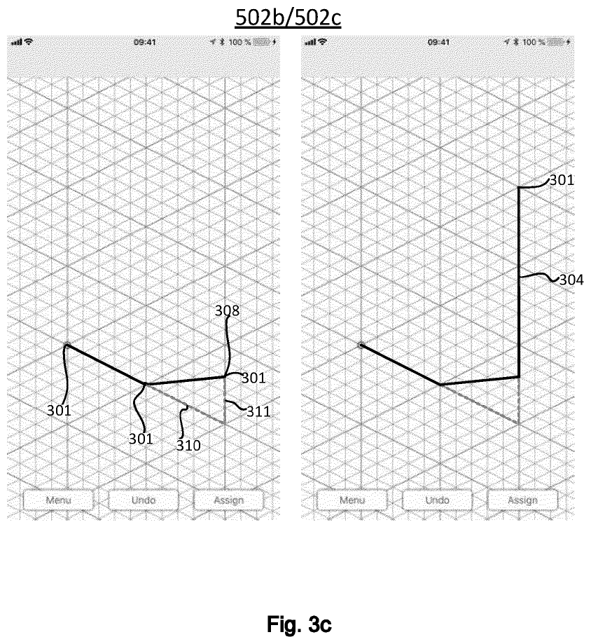

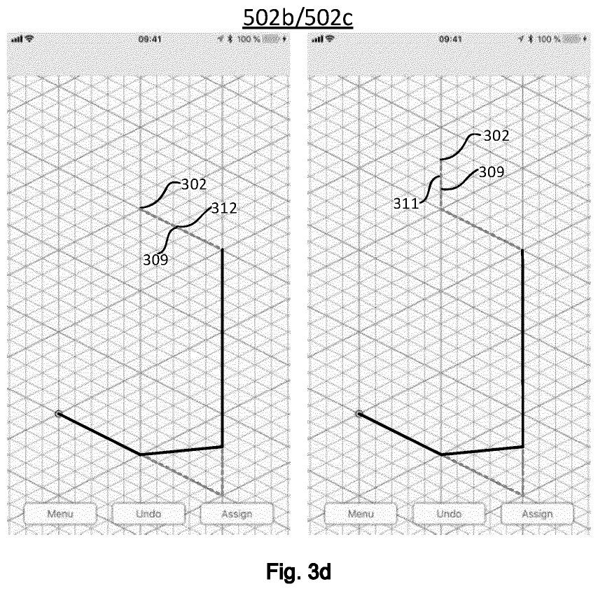

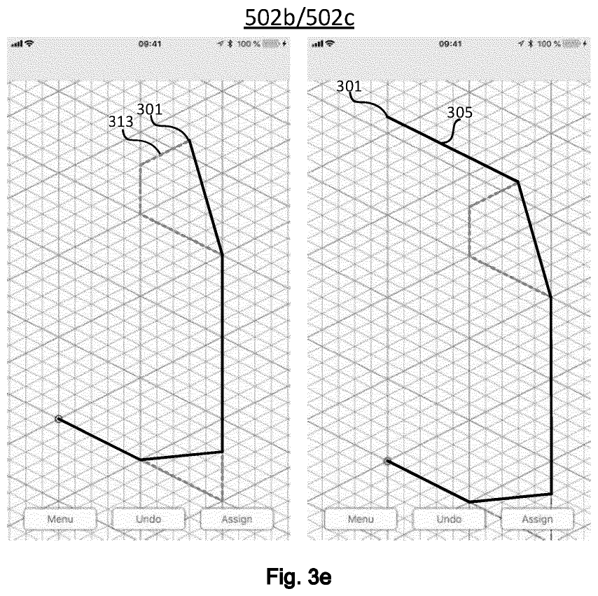

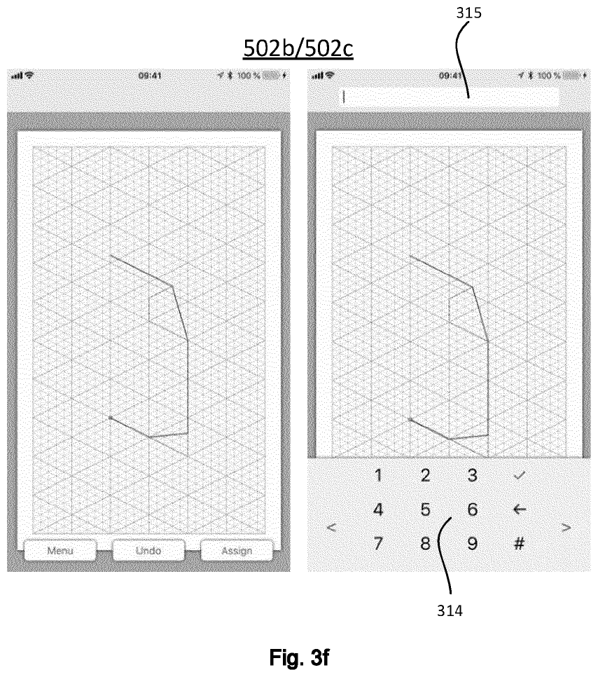

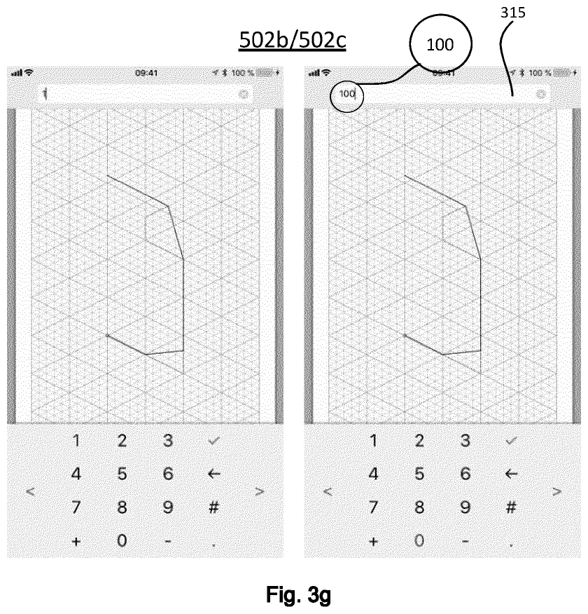

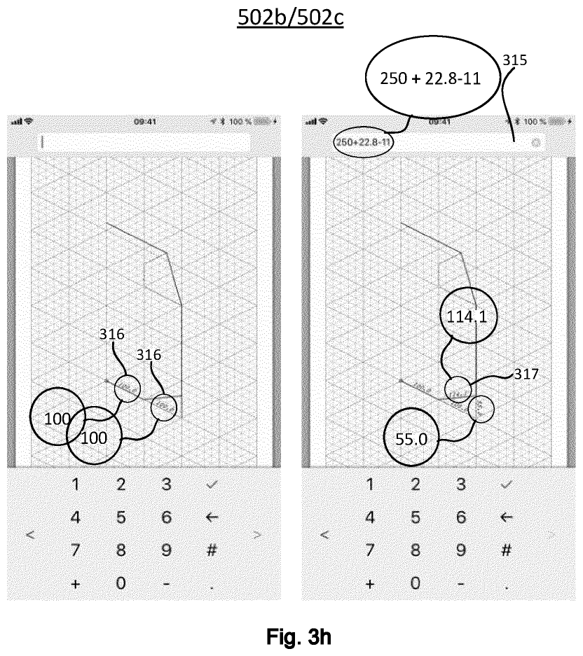

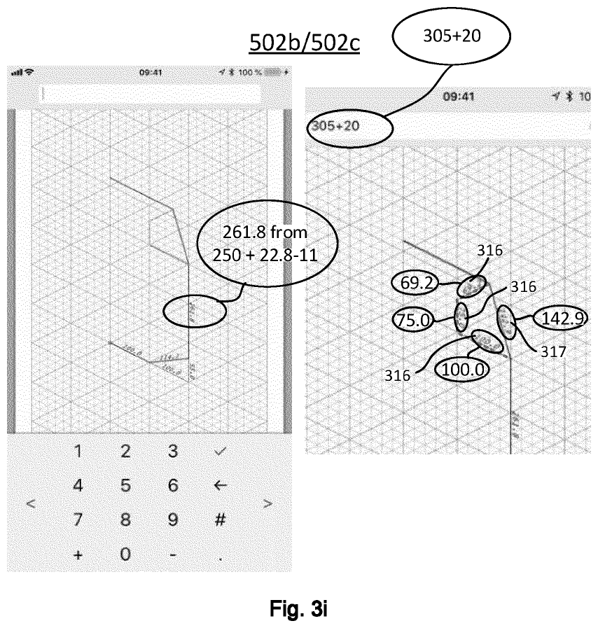

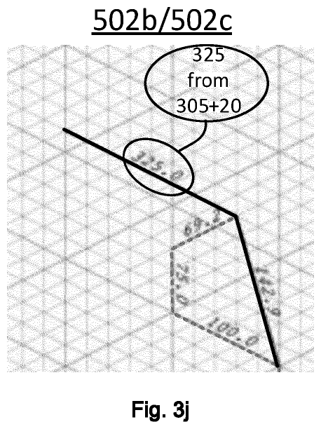

The tool 502a includes a visual graphical user interface 502c which simplifies tube layout/design for a user of the tool. Visual exemplification of an embodiment of the invention is illustrated in FIG. 3a-3j.

The graphic shown are screen dumps from a portable device 502 such as a smartphone. A prerequisite for the device is that it must include a display 502c, a user input interface 502b, memory at least for storing software application(s) in accordance with the present invention and at least one processing unit. The user input interface 502b and the display 502c can be physically separated from each other and from the CPU, however logically they will be part of the same device 502.

The graphical user interface 502b of the tool 502 allows a user to navigate by zooming and scrolling around in a drawing area visualised on a screen of the portable device. In one example tubing path can be created by adding points with a single tap of a finger or a pointing device. A line can be created between two points. Additional points can create a sequence of connected lines as a single object. A long press can create an offset line, allowing the user to sketch a tube that travels in multiple axis at once.

According to the present invention, one operates with 2D and 3D environments in real and virtually.

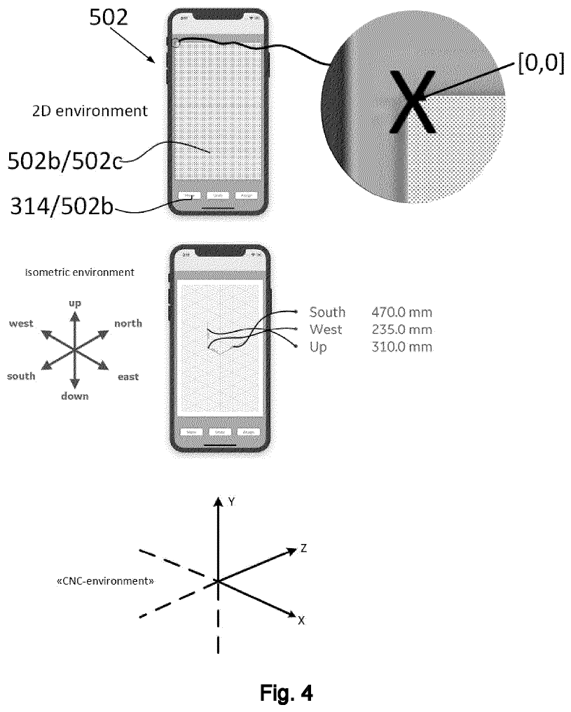

A first person 501 operates on a 2D screen with the aim to create 3D tubes with bends according to the representation on the 2D screen ref. FIG. 4. To help the first person make drawings on a 2D screen he is according to the present invention provided with isometric drawing grids on a 2D screen. A 2D screen on a portable device 502, such as a smart phone, has a two coordinate system, X, Y with X=0 and Y=0 normally arranged in the upper left corner of the screen. On the screen, which is 2D, one operates with X and Y-coordinates. An isometric grid on a display unit 502c is 2D however; it is suitable to represent 3D having three axis defining the grid. These three axis are denoted directions EAST, NORTH, UP, WEST, SOUTH, and DOWN. When a first person 501 draws tubes, as lines, on the isometric he operates in a virtual 3D environment as he operates with three axis (NORTH, SOUTH DOWN etc.) on a 2D screen (X, Y-coordinates). The use of cardinal points are appropriate for In-situ drawings. When a first user inputs “points” on an input unit 502b these inputs are in reality X,Y-coordinates of the input unit, such as a touch screen. The X,Y coordinates are “snapped” to a closest point in the isometric system and assigned direction UP, DOWN, NORTH etc. At the construction site where the tube bending takes place, tube bending CNC-machines operates with X, Y, Z coordinates.

Thus the UP, NORTH, DOWN parameters and lengths have to be converted to normal three-dimensional coordinate systems.

FIG. 4 illustrates how an isometric system can work as a way to define a three dimensional object on a two dimensional surface. The grid is built up of three lines all rotated at a relative 60 degree (approximately) angle. Each line represents an axis: X, Y and Z. Also referred to as, EAST, WEST (X), UP, DOWN, (Y) NORTH and SOUTH (Z).

An assign-button on a lower right (ref. FIG. 30 may present a user with a custom keyboard allowing the user to assign a length to each of the drawn lines. In addition, it may be possible to insert angles, angles and length of lines or offset lines. The keyboard may be configured with maths symbols/operators. The user may do simple mathematics like addition and subtraction as well as calculation of a two or three-dimensional vector by using math symbols and math operators.

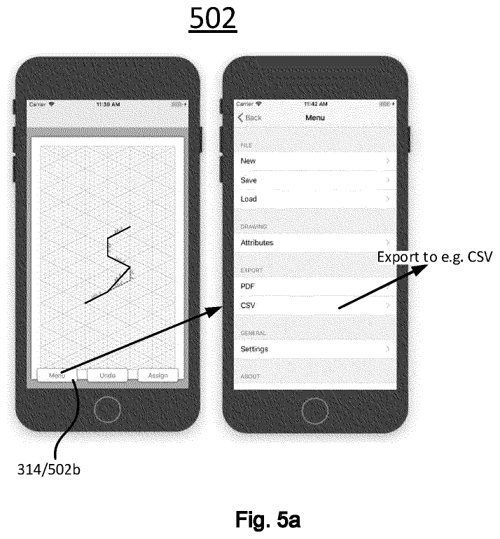

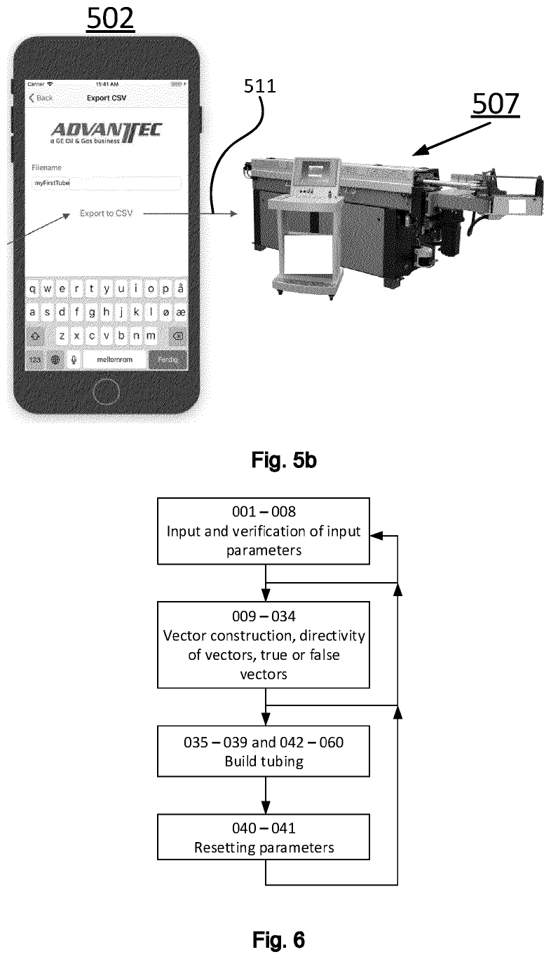

In one embodiment of the invention the tool has an ability to generate CSV-files (comma-separated values) containing X, Y and Z coordinates, see FIG. 5b. CNC-machines traditionally operates with vectorised data formats, however some CNC-machines can accept other formats such as raster formats and convert it internally. The CSV files generated by the tool may be vectorised to be compatible with CNC-machine languages. If the CSV-files are in a raster format they may have to be converted to vectorised format in the CNC-machine or on an intermediate platform between the tool and the CNC-machine. The CSV-files may be converted to files for CNC-machines such as G-data files in the tool, or on an intermediate platform, such as an intermediate computer in communication with the CNC-machine. This allows a user to draw tubing on a portable device and to send the CSV-file to a CNC machine operator 505. The only thing left to do is to feed the CNC tube-bending machine with the correct amount of tubing, pre-cut according to specification, and then initiate a bending process.

Another feature of the tool is the ability to generate PDF documentation. This enables the possibility to easily perform reverse engineering and to provide a better documentation control. As-built drawings can be generated by an operator 501 along the way.

Advanced devices with computational capacity and processing capacity such as state of the art portable devices opens UP for augmented reality. With augmented reality a user will be able to generate a three dimensional model of the tubing drawn. By looking through a camera of the portable device with the 3D-object rendered as a layer on top, the operator can get a clear picture of what the tubing would look like on the end product/system.

### An Exemplified System According to the Present Invention.

Reference is made to FIG. 5a and 5b which shows a system according to the present invention where a portable device 502 is in indirect communication with a CNC-machine 507.

The system comprises the portable device 502, which includes a software algorithm 502a for a CNC-parameter generating method in an isometric projection environment for the control and processing of tubes by at least one CNC-tube bending machine. The portable device comprises an input unit 502b or in one embodiment is in operable communication with an input unit 502b. Moreover, the portable device 502 also comprises a display unit 502c. The display unit 502c can be an integral part of the portable device 502 or it can be in operable communication with the portable device 502. In one embodiment, the display unit 502c is a touch screen thereby also functioning as an input unit 502b. The software can be stored in a local memory. The local memory can be included in the portable device 502.

Principles Applied for Transformation Between Paper Based Isometric Drawing Regime and Software Implemented “Isometric” Drawing Regimes.

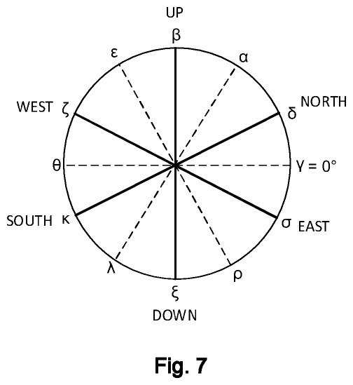

The isometric grid operates with 60° between all adjacent axis (360°/6), see FIG. 7, where the solid lines represents the main axis, NORTH, UP, WEST, SOUTH, DOWN and EAST.

When a pipe designer makes his drawing on an isometric paper, he simply draws lines following the axis on the paper. If a tubing shall be drawn upward, then he simply draws a vertical line on the isometric grid paper. If the tube shall bend for example to the right after the elevation, he will follow an eastern axis and so on. Having finalised a drawing he will measure distances between tube bends and add them on the drawings. Having finished his drawings, he will bring the drawing to someone who can transform the drawings into data files for production of tube systems on CNC-bending machines. This transformation from drawings to data may include geometric calculations.

Contrary to the manual operation above, according to the present invention any geometric calculation can be made on site on the portable device 502, also the portable device 502 can carry out conversion from on screen drawings to a data format that is suitable for conversion to CNC-readable data.

Conversion from on screen drawings, which essentially is carried out by tapping a finger or a pointing device on the screen, to real true models of a tube system necessitates some algorithms which takes into account whether input screen data is true or not, is a drawn vector north or east, etc. Reference points, reference angles etc. have to be introduced on the “isometric” pattern on the portable device.

Pixels are commonly used to represent on screen points on digital devices. Tube bending designs operates in 3D with vectors, hence the idea of working with isometric coordinate systems. The visual world around us is three-dimensional, display devices are 2D devices showing projections of 3D objects into 2D. “Projection” is, in simple terms, the way we “flatten” a 3D view into 2D.

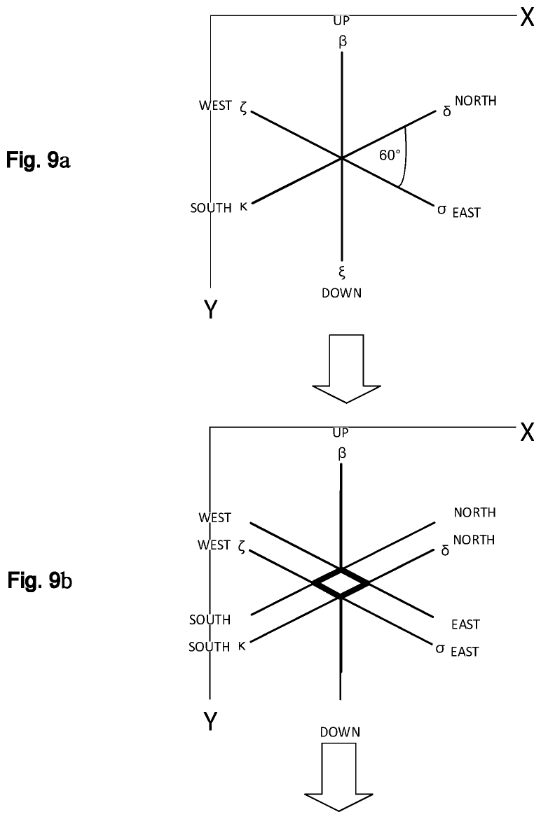

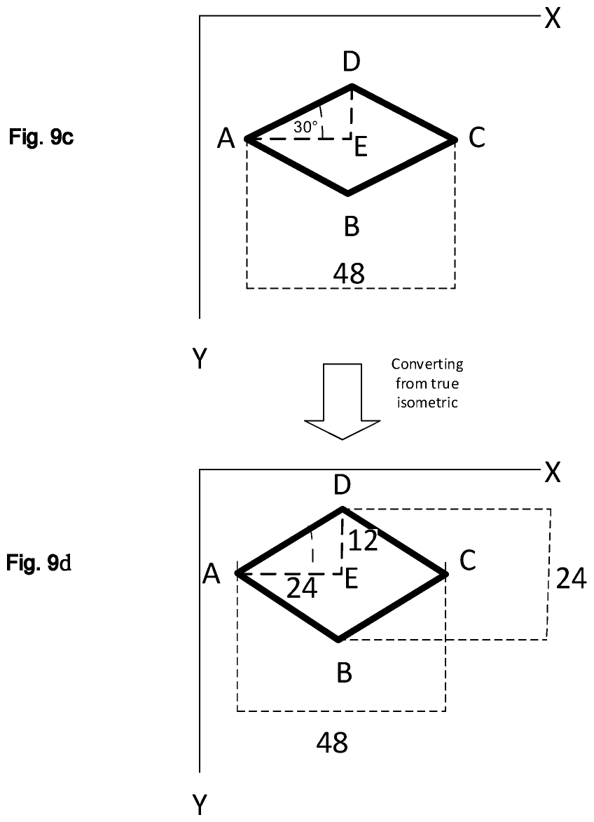

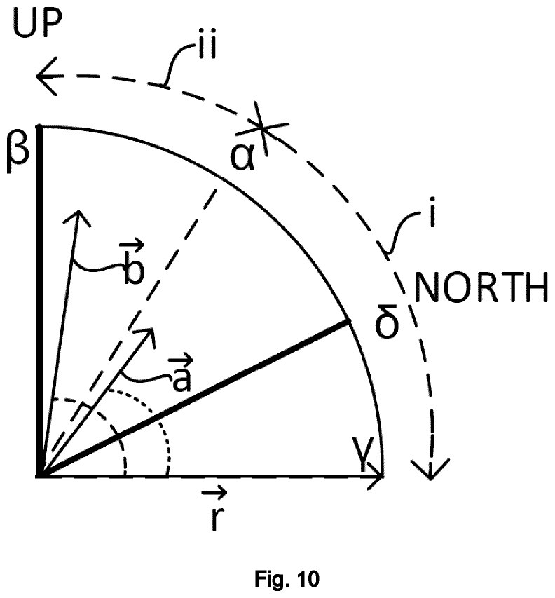

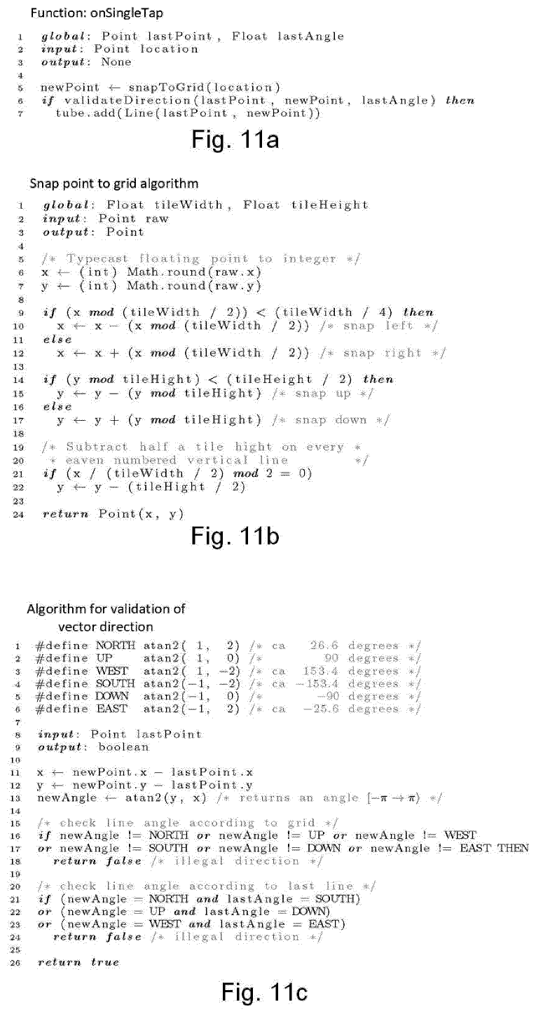

FIG. 9a-9c shows how grid pattern in an isometric drawing creates rhombs, see in particular FIG. 9b. Rhombus shaped tiles can be used as the smallest elementary building blocks in an isometric reign. NORTH, WEST, SOUTH and EAST represents a horizontal plane, whilst UP and DOWN represents elevation. A square will appear as a rhombus tile in a horizontal plane in an isometric grid.

FIG. 9b shows a tile marked out in an isometric grid, such a tile is chosen as an elementary “building block” in an “isometric” system according to the present invention. In true isometric projection, grid lines are all at 30 degrees and each segment represents the same length—making it useful in engineering diagrams. To be able to make calculations of sizes and directions for drawings on an isometric pattern on a screen it is necessary to find the dimensional values of a tile.

FIG. 9c shows a tile in an isometric grid, it is important to know the length of the sides of the tile and the length of elevation, the vertical height of the tile. Point A is chosen as origin [0,0]. If point D (FIG. 9c) is calculated then we will have a measure of the length of A-D as well as a measure of the elevation of E to D. In this example, the horizontal length of the tile is chosen to be A-C. The following applies:

$$A = [ 0 , 0 ] \\ AE = \frac{AC}{2} \\ ED = \frac{AC}{2} tan v \\ D = [ \frac{AC}{2} , \frac{AC}{2} tan v ] \qquad Eq . 1$$

In one example the tile length AC=48 pt., whilst the angle v is 30° as the tile is extracted from a true isometric grid. With the given length of AC, D is:

ED= 48/2 tan 30°

ED=8\sqrt{3} Eq. 2

D≈[24.8\sqrt{3}]

With the length of ED and AE it is easy to arrive at the length of AD by the use of Pythagorean Theorem. The decimal value of D with the angle v=30° includes a large number of decimals; this prevents an efficient calculation by a processor. Hence, true isometric grids is not CPU-efficient. To increase the performance of the calculations and thereby the speed of the algorithms according to the present invention, a twist in the isometric grid pattern is introduced. The goal is to have an isometric grid pattern which “looks” as a real isometric grid pattern while simultaneously increasing the performance of calculations carried out for objects drawn in a grid pattern. This goal will be achieved if we can find an angle v that renders the point D as an integer. Instead of being bound to a 30°“system” we can start opposite around and choose BD to be 24 instead of 2*8\sqrt{3}, this is an integer value fairly close to 16\sqrt{3} and it will render the overall impression of the grid system similar to a true isometric system, even though in reality it is a diametric grid pattern. Note that 16\sqrt{3} comes from 2*8\sqrt{3}, (Eq. 2). The vector lengths assigned to the “new tile” is AC=48 pt. (as in the previous tile) and BD=24 pt. We now have:

$$A = [ 0 , 0 ]$$

$$AE = \frac{AC}{2} = \frac{48}{2} = 24$$

$$ED = \frac{BD}{2} = \frac{24}{2} = 12$$

$$D = [ 24 , 12 ]$$

So, what is the new angle ∠DAB and what is the difference between the new angle and the isometric 60° angle?

∠DAB=2∠DAE

∠DAE=tan⁻¹ 12/24

∠DAE≈26.565° Eq. 3

∠DAB≈2*26.565°

∠DAB≈53.130°

The elementary tile according to the present invention then includes the following angles: ∠DAE≈26.565, ∠DAB≈53.130,

$$∠ CDA = \frac{360 ° - 2 ∠ DAB}{2}$$

and the following vector lengths: AC=48 pt., BD=24 pt., ED=12 pt. from Pythagorean Theorem |AD|=|AB|=|BC|=|CD|={square root over ((AE²)}+ED²), |AD|=|AB|=|BC|=|CD|≈26.8328.

Having established an appropriate grid pattern with an elementary tile which emphasizes on CPU-computational efficiency the basis for an algorithm that provides a CNC-parameter generating method in an isometric projection environment have been laid.

### Example of Algorithms for a Software Tool on a Portable Device According to the Present Invention.

In the following discussion when referred to isometric, isometric shall include the diametric projection as introduced with reference to FIG. 9d. Reference is made to FIG. 6, which shows major steps in an algorithm for a CNC-parameter generating method in an isometric projection environment for the control and processing of tubes by at least one CNC-tube bending machine.

The aim of the algorithm is to facilitate generation of CNC-parameters in situ by a first person 501, having at his disposition a portable device 502, where the portable device 502 has capabilities as indicted above. The first person 501 can, according to the algorithm, create tube-bending drafts on screen on the portable device; export the draft as data to a receiving computer 506 and/or CNC-tube bending machine 507 for production of tubes according to the layout of the on screen draft.

The on-site first person 501 can be a field technician with knowledge in the art of designing tube layout systems. The first person 501 will, faced with a construction site where tubes are to be installed start taking measurements of tube paths, draw the tubes on the screen of his portable device 502 and add measurement of tube path to the portable device. Ultimately, the first person 501 may receive tubes with tube bending in accordance with his draft from one or more tube-bending machine 507.

In FIG. 6, a first block 001-008 of the algorithm is indicated. The first block 001-008 is an “input of data” and “verification of valid input test block” indicating several substeps 001 to 008, the substeps 001-008 are examples and other substeps can lead to an “input of data” and “verification of valid input test block”. In a first step of the algorithm, the first person 501 inputs/taps 301 on the screen 502c of a portable device 502 the first input/tap 301 will result in a point being displayed on the screen 502c. In an embodiment the screen 502c presents an isometric drawing environment to the first person 501, see FIG. 3a-3b. The first point entered by the first person 501 can be anywhere within a valid part of the presented isometric screen 502c. The valid part is normally the entire isometric patterned portion of the screen 502c. From this first point, the first person 501 will add a second point in any direction. If the next point is vertically oriented compared to the first point then the first person 501 indicates a vertical vector, i.e. in Y-direction, which in the isometric environment is depicted “UP”. The directions of the lines of the isometric drawing “sheet” is indicated in FIG. 3a-3j and 7. The horizontal plane is commonly defined by the NORTH-SOUTH axis and EAST-WEST-axis. Vertical elevation is defined by UP-DOWN-axis.

Having entered points to the screen the points entered must be verified as valid 008 in a “vector length” test. In the second block 009-034 of FIG. 6 a verification of an entered vector is carried out, moreover the direction of a vector is determined.

If two points are too close to each other on the screen, it is assumed that one of the points are invalid and for example caused by an unintentional “double-tapping”. Another reason to avoid points from being too close to each other is that it will result in short lines, which will give little space for labelling lines. Therefore, it is carried out a test measuring the absolute length of a vector, and if the vector is below a threshold set to Tₕ the user will be requested to add a new second point, which together with the already entered first point will establish a line. The distance between the second—new point—and the original first point is measured and tested again. Following the “vector length”-test (substep 008) a vector orientation step is carried out 009-033. It must be verified that a correct orientation of the vector has been entered/drawn. For example, self-collision test(s) must be carried out. If a second vector is drawn opposite, of a previous vector then the two vectors will overlay each other indicating a tubing crash and this is not acceptable. If an opposite planar direction of a vector shall be valid, it must have a vertical UP or DOWN vector in between itself and a previous vector, i.e. SOUTH vector cannot follow directly after a NORTH vector. In addition, the absolute length of the UP or DOWN vector must be above a threshold Tᵥ to prohibit a too sharp bend and to prohibit self-crash, due to the thickness of the tubes. A bend that is 180° may be handled by the software for CNC-parameter generation 502a as two consecutive 90° bends in line, where the bends can be two times the bending radius.

If the vector test fails then the first person 501 will have to restart input of parameters for the relevant vector.

Further vectors are entered/drawn in the third block 035-039 and 042-060, FIG. 6.

When the first person 501 has finished his drawing of the tubes FIG. 3a-3f he can enter dimensional values for the vectors presented 3g-3j on the touch screen 502c. Geometric calculations are carried out by the software 502a of the portable device 502. As an example FIG. 3h “left” shows dimensional values for EAST and UP, whilst the software presents a calculation shown in FIG. 3h right showing the numeric length of an “EAST-UP”-vector. FIG. 3j shows a completed drawing of a tube-bending layout including all relevant measures.

The first person 501 may additionally enter bending angles for tubing used for calculation of 2D and 3D vectors.

A combination of input angle values and calculated angle values based on geometric and length of lines (vectors) is possible. For example, the first person may be faced with a system where angles of a previously known system shall be combined with a new system into one single new system. In one example a previously known system can be loaded into the portable device and the first person 501 may take observations in situ and add them into his portable device building on the system already loaded into the portable device 502.

The final step on the portable device 502 is to transfer dimensional values from the portable device 502 to one or more computers 503, 506, where the one or more computers are in communication with one or more CNC-tube bending machines 506. In addition, where one of the computers 503 can be used for generation of documentation.

The algorithm above with reference to FIG. 6 indicates one general example for facilitating generation of CNC-parameters in situ by a first person 501, having at his disposition a portable device 502.

The algorithm above is simplified among others in that the verification routines were simplified. All points entered and all vectors calculated from entered points must be software checked to verify that they represent true data.

FIG. 7 shows a sectored “unity circle”. The solid lines represents the “valid” directions, NORTH, UP, WEST, SOUTH, DOWN and EAST. Each solid line forms an angle with a horizontal line, the solid lines represents the lines in the pattern shown on the screen 502c of a portable device 502 shown in FIGS. 3a-3j, these lines represents the “valid” directions. Directions deviating from the valid directions are entered on the screen 502c by pressing 302 and not tapping 301 on the screen 502c, the pressing 302 refers to FIG. 6 substeps 035-039 and 042-060. NORTH forms an angle δ with reference to 0° (γ). The other solid lines forms the following angles: UP=β, WEST=ξ, SOUTH=κ, DOWN ξ and EAST=ρ. When tapping 301 on the screen 502b/502c it will in practice be impossible to hit a solid line, representing directions in the isometric grid pattern system, thus an algorithm or software routine will have to handle “hits”—tap 301 on the screen 502c that do not correlate precisely with tiles/isometric pattern. A bisection algorithm is introduced to snap a tap (hit) to a nearest solid line (FIG. 7); each of the dotted lines represents a bisection between neighbouring solid lines—directions. For example

$$α = \frac{β + δ}{2} .$$

The following applies: [Eq 4]

$$α = \frac{β + δ}{2} and ɛ = \frac{β + ζ}{2} and θ = \frac{ζ + κ}{2} and$$

$$λ = \frac{κ + ξ}{2} and ρ = \frac{ξ + σ}{2} and γ = \frac{σ + δ}{2} ⇒ \\ ; putting in numeric values$$

$$α \approx \frac{90 ° + {25.565}^{-} °}{2} and ɛ \approx \frac{90 ° + 153.435 °}{2} and θ \approx \frac{153.435 ° + 206.565 °}{2} and$$

$$λ \approx \frac{206.565 ° + 270 °}{2} and ρ \approx \frac{270 ° + 333.435 °}{2} and γ \approx \frac{- 26.565 ° + {26.565}^{-} °}{2} ⇒ \\ α = 58.283 ° and ɛ = 121.718 ° and θ = 180 ° and$$

$$λ = 238.283 ° and ρ = 301.718 ° and γ = 0 °$$

To decide to which solid line a “finger tap” on the screen belongs the bisection lines—dotted lines—are used. If a tap “pt” is made such that the angle represented by a vector from origin to “pt” with reference to γ is smaller than α and bigger than γ it belongs to NORTH. This bisection concept is used for all directions (NORTH, UP, WEST, etc.). Too not exclude angles that have the exact same angle as α, β, γ, etc. the algorithms may at an upper limit or lower limit include the bisection angle, e.g. [symbol] α, γ [symbol] . In practice, this will be of academic interest as the resolution normally will be high and the probability of “tapping” spot on a fixed angle (α, β, γ, etc.) is small.

A practical resolution hampering double taps to be registered has to be decided, effectively discriminating “vectors” that are shorter than a threshold—resolution. As indicated for the general routine above, if two points are too close to each other on the screen it is assumed that one of the points are invalid and for example caused by an unintentional “double-tapping”. If a vector is below a threshold set to Tₕ, it is assumed that the vector, i.e. the last point is erroneous. In a practical example Tₕ=(20 pt, 80 pt) and in one particular embodiment Tₕ=40 pt. merely as an example.

An example of determination of vector orientation can in detail be carried out as indicated in the software routine in the box below, note that the numerically assigned angles are associated with the dotted lines of FIG. 7, please refer to FIG. 3c and 3e for examples

Several approaches can be chosen to determine; whether an onscreen tap 301 is valid or not, whether a following tap 301 represents a valid vector, which direction the vector shall be appointed to and whether the tap 302 is a tap or a “press” 302. Onscreen press 302 indicates, according to one embodiment that a vector shall be drawn in a way which departs from the solid lines of FIG. 7 and Eq 4.

With respect to appointing a vector to a “true” direction in accordance with FIG. 7, it shall be remembered that trigonometric functions does not in a unique way distinguish between quadrants, thus an algorithm is needed to for example distinguish between NORTH (first quadrant) and SOUTH (third quadrant), if a tangent function is used to decide a vector angle. According to the present invention three different approaches are presented, a first one where one takes into account that the sign of the “x, y”-coordinates on a screen 205c dictates which quadrant a vector angle is, a second one wherein angle ranges are assigned in each quadrant and subroutines setting up conditional tests for each assigned sector for the full 360° circle, the third algorithm separates between NORTH, UP, WEST and SOUTH, DOWN, EAST where the three latter represents a positive y coordinate according to one variant of the present invention.

The first approach, the “quadrant method” takes into account that trigonometric functions such as cosines, sines and tangent “repeats” itself periodically and it will be sufficient to first find out if a vector belongs to NORTH or UP in the first quadrant as a first intermediate step and then establish conditional tests which takes into account the sign of X and Y. The signs of X and Y will vary between quadrants. In a Cartesian system first quadrant means that bot X and Y≥0 however, in accordance to one variant of the present invention it is convenient to have a positive Y pointing downward, this simplifies the software algorithms. A first intermediate vector component angle, vcaᵢₙₜ, is established by using absolute values X and Y vector component coordinates, in a next step it is decided if the true vca belongs to first, second, third or fourth quadrant. For example:

$${vca}_{int} = {tan}^{- 1} \vert \frac{Y}{X} \vert$$

| | | |
|---|---|---|
| If γ ≤ vcaᵢₙₜ ≤ α then vca is: | NORTH if: | Y < 0 and X > 0 |
| | WEST if: | Y < 0 and X < 0 |
| | SOUTH if: | Y > 0 and X < 0 |
| | EAST if: | X > 0 and Y > 0 |
| If α < vcaᵢₙₜ < β then vca is: | UP if: | Y < 0 |
| | DOWN if: | Y > 0 |

In the table above we take into consideration that

$${tan}^{- 1} \vert \frac{Y}{X} \vert$$

will vary between 0 and near to 90°.

In a twist of the “quadrant method” above

$${vca}_{int} = {tan}^{- 1} \frac{Y}{X} ,$$

which means that the value of tan(vcaᵢₙₜ) is the same for each 180°, i.e. tan α=tan (α+180°). The same principle as in the table above applies, which gives:

| | | |
|---|---|---|
| If γ ≤ vcaᵢₙₜ < α then vca is: | NORTH if: | Y < 0 and X > 0 |
| | SOUTH if: | Y > 0 and X < 0 |
| If − α ≤ vcaᵢₙₜ < γ then vca is: | EAST if: | Y > 0 and X > 0 |
| | WEST if: | Y < 0 and X < 0 |
| If α ≤ vcaᵢₙₜ < β then vca is: | UP if: | Y < 0 |
| | DOWN if: | Y > 0 |
| If − β < vcaᵢₙₜ < − α then vca is: | UP if: | Y < 0 |
| | DOWN if | Y > 0 |

The second approach is illustrated in the table below.

Box 1

// Flip coordinate system
vector.setY(newValue: vector.getY( ) * −1)
//Find the direction based on the vector angle
//Then correct angle, following a bisection method
var dir: Direction?
let angle = Vector.getAngle( )
if angle >= 0 && angle < 58.283 { // Angle between (and including) γ and α
dir = .north
vector.setAngle(newValue: 26.565) // Vector angle set to δ (NORTH)
} else if angle >= 58.283 && angle < 121.718 { // Angle between α and ε
dir = .up
vector.setAngle(newValue: 90) // Vector angle set to β (UP)
} else if angle >= 121.718 && angle < 180 { // Angle between ε and θ
dir = .west
vector.setAngle(newValue: 153.435) // Vector angle set to ζ (WEST)
} else if angle >= 180 && angle < 238.283 { // Angle between θ and λ
Dir = .south
vector.setAngle(newValue: 206.565) // Vector angle set to κ (SOUTH)
} else if angle >= 238.283 && angle < 301.718 { // Angle between λ and ρ
dir = .down
vector.setAngle(newValue: 270)
} else if angle >= 238.283 && angle < 360 { // Vector angle set to ξ (DOWN)
dir = .east
vector.setAngle(newValue: 333.435) { // Vector angle set to σ (EAST)
}
//Verify that a direction was assigned
guard let direction = dir else {
print(“Error, could not assign direction”)
return
}
//Flip coordinate system back
vector.setY(newValue: vector.getY( ) * −1)

A first intention of the software routine above is to provide a 0-360° range for vectors. First step is to turn the vector coordinate system up-side down so that the Y-component in the 2D space is pointing upward. Note that by default the coordinate [0, 0] is located at the top left corner of the display unit 502c. In order to make the code easier to reed, we flip the coordinate system. Now the coordinate [0, 0] is located in the lower left corner of the display unit 502c—as one commonly know it from mathematics. The flip of the coordinates is a measure for user friendliness and is not necessary to carry out the invention, though in the software 502a one has to take account for whether the Y-coordinates are upside down or not. Thereafter the angle of the vector is determined. Determination of vector angles are simply carried out by series of tests, wherein it is tested if a vector end point lies between two particular dotted lines, starting with γ and α, if the first test is true the point is assigned to the NORTH axis giving a vector with a NORTH direction. If the test fails, a new range is tested until one has tested for all six directions. To carry out the determination of the angle a virtual reference vector [1,0] is introduced. It is not due to the coordinate system being flipped that an angle between 0-360 degrees can be determined. This is due to a custom method “getAngle” which checks whether the X- or Y component of a vector are positive or negative.

If both X & Y are positive, this indicates first quadrant, and if X is negative and Y is positive, it is an indication of the second quadrant and so on.

By knowing which quadrant the vector is located in, one can add 0/180/360-degrees, based on use of tangent, where an angle is found based on the length of decomposed X-vector and Y-vector. This is in contrast to the use of trigonometric functions such as Cosines, Sines or Tangent, which works within a range of ABS (0-90°).

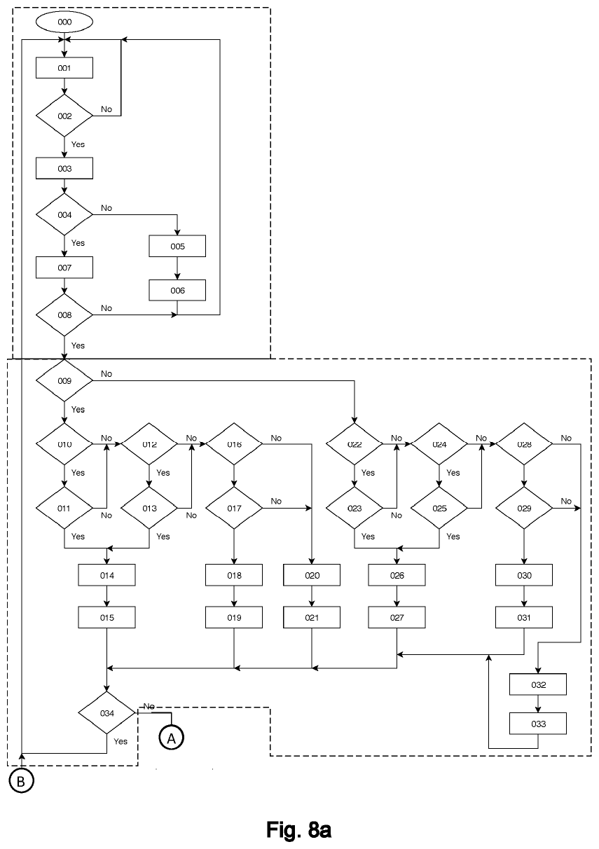

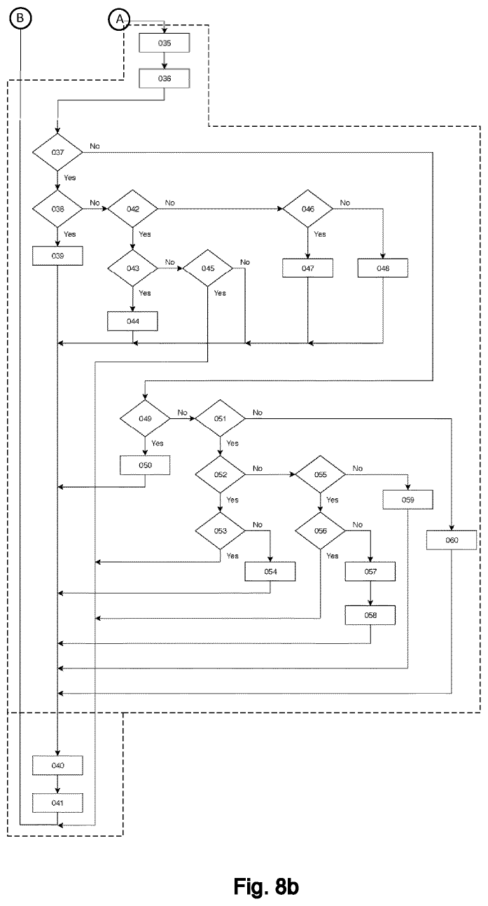

Below follows a routine, which is associated with FIG. 8a-8b and which represents the embodiment where the sign of y-coordinate determines NORTH, UP, WEST vs SOUTH, DOWN EAST. It can be seen that the “vector length test/double tap test is carried out in step 008, where Tₕ in this particular example equals 40 pt. Further comments to the steps 000-060 are given to the right in italic underscore starting with “//”.

Box 2

000: Begin
001: Wait for user input
002: Is input location inside drawing area?
003: Snap input location to grid
004: Is there a first point?
005: Create a first point
006: Make last point equal to first point
007: Create a vector between last point and input location
008: Is vector length greater than 40 pt? //A test against double tapping/erroneous
input,
009: Is vector Y-component less than zero? (Upper left corner defines origin in an
Cartesian coordinate system) //Taking into consideration that “YDOWN” is positive
this means that a yes gives the directions UP, WEST or NORTH,
010: Is vector angle greater than 58.283 degrees? //Vector angle > α? No continue at
12
011: Is vector angle less than 90.000 degrees? //Vector angle < β? No continue at 12,
Yes, continue at 14
012: Is vector angle greater than −90.000 degrees? //Vector angle > ξ, (numeric value)
no continue at 16
013: Is vector angle less than −58.283 degrees? //Vector angle smaller than ρ, no
continue at 016
014: Adjust vector angle to |90.0| degrees //That is vector between α and β is
interpreted as β i.e. UP, whilst between ξ and ρ is interpreted as ξ i.e. DOWN
015: Set tubing object variable direction to ‘up’ //Continue at 034
016: Is vector angle less than or equal to 58.283 degrees?
017: Is vector angle greater than or equal to 0.0 degrees?
018: Adjust vector angle to |26.565| degrees
019: Set tubing object variable direction to ‘west’
020: Adjust vector angle to |26.565| degrees
021: Set tubing object variable direction to ‘north’
022: Is vector angle greater than 58.283 degrees?
023: Is vector angle less than 90.000 degrees?
024: Is vector angle greater than −90.000 degrees?
025: Is vector angle less than −58.283 degrees?
026: Adjust vector angle to |90.0| degrees
027: Set tubing object variable direction to ‘down’
028: Is vector angle less than or equal to 58.283 degrees?
029: Is vector angle greater than or equal to 0.0 degrees?
030: Adjust vector angle to |26.6| degrees
031: Set tubing object variable direction to ‘east’
032: Adjust vector angle to |26.5, 65| degrees
033: Set tubing object variable direction to ‘south’
034: Is direction opposite of last direction? //Vector direction settled, however is it
valid, yes means that tube is self crashing, if yes continue at 001
035: Create a new point [x: (last point x-component + vector x-component), y: (last
point ycomponent + vector y-component)]
036: Snap new point to grid
037: Is touch type ‘tap’? (Else touch type ‘press’) //Touch type press means tubing
don't follow main axis directions, if no continue at 049
038: Does tubing object not contain any previous lines?
039: Add a black solid line to the tubing object from last point to new point
040: Last point equals new point
041: Last direction equals direction
042: Is a green dotted line expected?
043: Is the line in the same direction as the last direction?
044: Merge lines
045: Does any lines in the same fraction go in the same or opposite direction?
046: Is the line in the same direction as the last direction?
047: Merge lines
048: Add a solid line to the tubing object from last point to new point
049: Does tubing object not contain any previous lines?
050: Add a green dotted line to the tubing object from last point to new point
051: Is the last line a green dotted line?
052: Are there less than 2 green dotted lines in this fraction?
053: Does any lines in the same fraction go in the same or opposite direction?
054: Add a green dotted line to the tubing object from last point to new point
055: Are there less than 3 green dotted lines in this fraction?
056: Does any lines in the same fraction go in the same or opposite direction?
057: Add a green dotted line to the tubing object from last point to new point
058: Add a black solid line from fraction start to end
059: Add a solid line to the tubing object from last point to new point
060: Add a green dotted line to the tubing object from last point to new point

The two tables above describes different approaches to determine vector angles to be calculated after a first operator 501 has entered vector coordinates by tapping twice on the screen 502c. The second table, algorithm, includes steps to verify if valid coordinates have been entered by the first operator 501, double tapping is checked as well as the length of a vector. The second table also includes algorithms for onscreen entries that deviates from the entries associated with entries that renders vectors coinciding with the six directions, NORTH, UP, WEST, SOUTH, DOWN and EAST. The first table includes steps for decision directions, i.e. UP, DOWN etc. The steps given in table one are alternatives to the steps given in step 009-033 in table 2, also see FIG. 8a.

A portable device 502 is defined above, it shall be understood that the elements indicated as integrated with the portable device 502, such as a touch screen etc., is logically integrated, physically they can be split. For instance, a “dumb” input device 502b in the form of a touch screen 502c may communicate with software program 502a in a microprocessor device 502, in a physically decentralised system.

### Another Example of an Algorithm for a Software Tool on a Portable Device According to the Present Invention.

Function onSingleTap is called when an operator taps the finger on a grid on the portable device. The touch location sent as a parameter gets snapped to the grid and a line is drawn from a previous location to the new location. The line is then validated according its direction as well as the direction of the previous line. This is to prevent the operator from drawing the line on top of the last line and to prevent the operator from drawing lines that do not conform with the grid lines on the portable device.

Listing 1: onSingleTap

Box 3

| | |
|---|---|
| 1 | global: Point lastPoint, Float lastAngle |
| 2 | input: Point location |
| 3 | output: None |
| 4 | |
| 5 | newPoint ← snapToGrid (location) |
| 6 | if validateDirection (lastPoint, newPoint, lastAngle) then |
| 7 | tube.add(Line(lastPoint, newPoint)) |

Snap Point to Grid

This algorithm receives a raw input from a touch screen and returns a new Point snapped to the closest junction in an isometric grid. Line number six in the box 4 below shows a two step conversion from a raw floating number input too; first a rounded number (up or down) and secondly to an integer, hence the raw floating number are converted to an X and Y integer. The variables tileWidth and tileHeight represents the distance between each junction. The line numbers 9-12 in box 4 decides whether the X integer parameter shall be snapped to the right or left in a tile, ref FIG. 9b, the same applies for tile height with respect to the integer parameter Y, ref line numbers 14-17.

Listing 2: snapToGrid

Box 4

| | |
|---|---|
| 1 | global: Float tileWidth, Float tileHeight |
| 2 | input: Point raw |
| 3 | output: Point |
| 4 | |
| 5 | /* Typecast floating point to integer */ |
| 6 | x ← (int) Math.round(raw.x) |
| 7 | y ← (int) Math.round(raw.y) |
| 8 | |
| 9 | If (x mod (tileWidth/2)) < (tileWidth/4) then |
| 10 | x ← x − (x mod (tileWidth/2)) /* snap left */ |
| 11 | Else |
| 12 | x ← x + (x mod (tileWidth/2)) / * snap right * / |
| 13 | |
| 14 | if (y mod tileHeight) < (tileHeight/2) then |
| 15 | y ← y − (y mod tileHeight) /* snap up */ |
| 16 | Else |
| 17 | y ← y + (y mod tileHeight) /* snap down */ |
| 18 | |
| 19 | /* Subtract half a tile height on every even numbered vertical line */ |
| 20 | if (x/(tileWidth/2) mod 2 = 0) |
| 21 | y ← y − (tileHeight/2) |
| 22 | |
| 23 | return Point (x, y) |

Validate Direction

The values x and y (listing 3) are calculated to be the x- and y component of a vector reaching from point lastPoint to point newPoint. The angle of this vector is calculated using the function atan 2. This angle is then used to check what direction the vector is pointing. An allowable angle will return a true value, i.e. If the vector does not conform in parallel with the gridlines or if the vector points in the opposite direction of the last line. The direction is considered illegal and user input is ignored, i.e. a false return is established ref. line numbers 15-24 in box 5.

Listing 3: validateDirection

Box 5

| | | |
|---|---|---|
| 1 | #define NORTH | atan2(1, 2) /* δ (ca 26.6) degrees */ |
| 2 | #define UP | atan2(1, 0) /* β (90 ) degrees */ |
| 3 | #define WEST | atan2(1, −2) /* ζ (ca 153.4) degrees */ |
| 4 | #define SOUTH | atan2(−1, −2) /* κ (ca −153.4) degrees */ |
| 5 | #define DOWN | atan2(−1, 0) /* ξ (−90) degrees */ |
| 6 | #define EAST | atan2(−1, 2) /* σ (ca −25.6) degrees */ |

| | |
|---|---|
| 7 | |
| 8 | input: Point lastPoint |
| 9 | output: Boolean |
| 10 | |
| 11 | x ← newPoint.x − lastPoint.x |
| 12 | y ← newPoint.y − lastPoint.y |
| 13 | newAngle ← atan2 (y, x) /* returns an angle [−π → π>*/ |
| 14 | |
| 15 | /* check line angle according to grid */ |
| 16 | if newAngle!=NORTH or newAngle!= UP or newAngle != WEST |
| 17 | or newAngle!=SOUTH or newAngle!= DOWN or newAngle != EAST THEN |
| 18 | return false /* illegal direction */ |
| 19 | |
| 20 | /* check line angle according to last line */ |
| 21 | if (newAngle = NORTH and lastAngle = SOUTH) |
| 22 | or (newAngle = UP and lastAngle = DOWN) |
| 23 | or (newAngle = WEST and lastAngle = EAST) |
| 24 | return false /* illegal direction */ |
| 25 | |
| 26 | return true |

### LIST OF REFERENCES

301 Tap
302 Press
303 EAST
304 UP
305 WEST
306 NORTH
308 EAST and UP
309 Green dotted line
310 EAST-component
311 UP-component
312 WEST-component
313 NORTH-component
314 Keyboard on touch screen, soft keyboard, or mechanic keyboard
315 Alphanumeric display area
316 Entered parameter/length value
317 Calculated length of tube section
501 Field technician, first operator
502 Smartphone/tablet with IsoTube application
502a Software program for CNC-parameter generation
502b Input unit
502c Display unit
503 Composition of documentation
504 Engineer
505 Machine operator
506 Compiling CSV-file to machine code with existing software
507 CNC tube bending machine
508 Tubing spool
509 Shipping
510 Drawing shared through the internet using cloud services, email or other technologies.
511 Data sent as a PDF or/and CSV
512 Data sent as CSV-file
513 Compiled machine instructions sent to CNC machine
514 Tubing spool is loaded in to the machine
515 Finished product is packed and ready for shipping
516 Tubing is shipped to customer or operator at customer site
Tₕ Threshold value, in one embodiment set to 40 pt, value is a question of configuration
Tᵥ Tv is a minimum value of a vertical vector. It is dependent on minimum bending diameter of the tubes in question and of the diameter of the tubes in question.
IoT Internet of the things
IIoT Industrial Internet of the Things
ABS Absolute value of vector or angle
PDF Portable Document Format (PDF) is a file format for presentation of documents, including text formatting and images, in a manner independent of application software, hardware, and operating systems.
ν In one embodiment ν=30°
α In one embodiment α=58.283°
β In one embodiment β=90.000°; UP
γ In one embodiment γ=0.0°
δ In one embodiment δ=26.565°; NORTH
ε In one embodiment ε=121.718°
ζ In one embodiment ζ=153.435°; WEST
θ In one embodiment θ=180.000°
κ In one embodiment κ=206.565°; SOUTH or in the alternative algorithm counting in the opposite direction rendering SOUTH=−153.435
λ In one embodiment λ=238.283°
ξ In one embodiment ξ=270.000°; DOWN (or −90°)
ρ In one embodiment ρ=301.718°
σ In one embodiment σ=333.435°; EAST (or −25.6°)
UP UP is an upward vector in an isometric projection environment for tube bending according to an embodiment of the present invention. A negative Y-vector component in a 2D projection corresponding to a touch screen projection as the [0,0] (origin) is on the upper left of a display unit 502c.
DOWN DOWN is a downward vector in an isometric projection environment for tube bending according to an embodiment of the present invention. A positive Y-vector component in a 2D projection corresponding to a touch screen projection display unit 502c.

NORTH NORTH is a vector in an isometric projection environment for tube bending according to an embodiment of the present invention. A positive X-vector component and a negative Y-vector component in a 2D projection corresponding to a touch screen projection (502c).
SOUTH SOUTH is a vector in an isometric projection environment for tube bending according to an embodiment of the present invention. A negative X-vector component and a positive Y-vector component in a 2D projection corresponding to a touch screen projection (502c).
EAST EAST is a vector in an isometric projection environment for tube bending according to an embodiment of the present invention. A positive X-vector component and a positive Y-vector component in a 2D projection corresponding to a touch screen projection (502c)
WEST WEST is a vector in an isometric projection environment for tube bending according to an embodiment of the present invention. A negative X-vector component and a positive Y-vector component in a 2D projection corresponding to a touch screen projection (502c).
vca Vector component angle, the angle of a vector, where the vector coordinates have been entered by a first operator 501, and where the angle is relative to a horizontal vector parallel with the X-axis pointing in a positive X-direction.

1: An on construction site CNC-parameter generating method in an isometric projection environment for the control and processing of tubes by at least one CNC-tube bending machine at least comprising:
a) to generate a first vector on a touch screen by tapping twice on the touch screen, the touch screen being in communication with a microprocessor device;
b) to carry out a verification step by the microprocessor, is the absolute value, length, of the first vector greater than a threshold value, Tₕ, if not continue with step a);
c) to assign the first vector to one of the six directions, NORTH, UP, WEST, SOUTH, DOWN and EAST;
d) is the vector assignment correct, if no continue with step a);
e) to generate further vectors by tapping once on the touch screen;
f) to input dimensional values for the vectors on the touch screen; and,
g) to transfer dimensional values from the microprocessor device to one or more computers, where the one or more computers are in communication with one or more CNC-tube bending machines.

2: The method according to claim 1, where step a) at least comprises:
ai) tapping a first input location parameter on the touch screen, the touch screen being in communication with the microprocessor device;
aii) verifying correctness of the first input location parameter,
i. if the first input parameter does not fit correctly in a set isometric grid pattern continue at point ai);
aiii) is the first input location parameter a first point, if no continue at av);
aiv) set the first input location parameter as the first point, and set last point equal with first point, continue at point ai);
av) create a vector between the first input location parameter and a last point.

3: The method according to claim 1, where step b) at least comprises:
bi) is the difference between the absolute value of the first input location parameter and the first point greater than a threshold value, Tₕ, the difference represents a first vector, if the difference is not greater than Tₕ then continue at point ai).

4: The method according to claim 1 where vector assignment step c) at least comprises:
ci) decide UP or DOWN orientation of vector:
if the Y-component is less than zero then continue at i);
if the Y-component is greater than zero then continue at ciii);
i. decide if vector Y-component is UP, if vector Y-component is UP then set vector Y-component UP and continue at vi);
cii) decide WEST or NORTH orientation of vector:
ii. decide if vector X-component is WEST, if vector X-component is WEST then then set vector X-component WEST and continue at vi);
iii. set vector Z-component to NORTH, and continue at vi);
ciii) decide if vector Y-component is DOWN, if vector Y-component is DOWN then then set vector Y-component DOWN and continue at vi);
civ) decide EAST or SOUTH orientation of vector:
iv. decide if vector X-component is EAST, if vector X-component is EAST then set vector X-component to EAST and continue at vi);
v. set vector Z-component to SOUTH;
vi. carry out a self crash test, is the vector orientation opposite of last direction, if the vector orientation is opposite then the next step will be to generate a first vector by inputting parameters on a touch screen, the touch screen being in communication with a microprocessor device.

5: The method according to claim 4 where substep i) at least comprises the further substeps of:
ia) carrying out vector component angle measurement;
is vector component angle greater than α, if no then continue with substep ib);
is vector component angle less than β, if no then continue with substep ib), else continue with substep ic);
ib) is vector component angle greater than −β, if no then continue with substep id);
α is vector component angle less than α, if no then continue with substep id)
ic) set vector component angle to ABS β and set vector Y-component UP;
id) if vector Y-component is UP then carry out a self crash test else decide if vector component is WEST or NORTH.

6: The method according to claim 5 where substep id) at least comprises the further substeps of:
carrying out a WEST or NORTH test:
is vector component angle less than or equal to α, if no then continue with substep ie);
is vector component angle greater than or equal to γ, if no then continue with sub step ie);
set vector component angle to ABS S and set vector component WEST;
ie) if vector component is WEST then carry out a self crash test else set vector component angle to ABS S and set vector component to NORTH then carry out a self crash test.

7: The method according to claim 4 where substep ciii) at least comprises the further substeps of:
ia) carrying out vector component angle measurement;
is vector component angle greater than α, if no then continue with substep ib);
is vector component angle less than β, if no then continue with substep ib), else continue with substep ic);
ib) is vector component angle greater than −β, if no then continue with substep id);
is vector component angle less than α, if no then continue with substep id)
ic) set vector component angle to ABS β and set vector Y-component DOWN;
id) if vector Y-component is DOWN then carry out a self crash test else decide if vector component is EAST or SOUTH.

8: The method according to claim 7 where substep id) at least comprises the further substeps of:
carrying out a EAST or SOUTH test:
is vector component angle less than or equal to α, if no then continue with substep ie);
is vector component angle greater than or equal to γ, if no then continue with sub step ie);
set vector component angle to ABS S and set vector component EAST;
ie) if vector component is WEST then carry out a self crash test else set vector component angle to ABS S and set vector component to SOUTH then carry out a self crash test.

9: The method according to claim 1, where the vector assignment step c) at least comprises the steps of:
c1) to set origin Y=0 and X=0 to upper left corner of the touch screen;
c2) to create a horizontal reference vector for measurement of first vector component angles;
c3) to carry out a first vector component angle test for assignment of one of the directions: NORTH, UP, WEST, SOUTH, DOWN and EAST.

10: The method according to claim 9, where the vector component angle test c3) at least comprises the steps of:
to carry out one or more of the six tests:
i. is vector component angle, vca, greater than or equal to γ and smaller than α, if yes then set vca=δ and continue at vii;
ii. is ε>vca α, if yes then set vca=β and continue at vii;
iii. is θ>vca ε, if yes then set vca=ζ and continue at vii;
iv. is λ>vca θ, if yes then set vca=κ and continue at vii;
v. is ρ>vca κ, if yes then set vca=ξ and continue at vii;
vi. is γ>vca ρ, if yes then set vca=σ and continue at vii;
vii. continue with step d.

11: The method according to claim 9, where the vector component angle, the vca, test c3) at least comprises the steps below where
$${tan}^{- 1} \vert \frac{Y}{X} \vert :$$
to carry out one or more of the six tests:
i. is γ≤vcaᵢₙₜ≤α and Y<0 and X>0 then set vca=δ, and continue at vii;
ii. is γ≤vcaᵢₙₜ≤α and Y<0 and X<0 then set vca=ζ, and continue at vii;
iii. is γ≤vcaᵢₙₜ≤α and Y>0 and X<0 then set vca=κ, and continue at vii;
iv. is γ≤vcaᵢₙₜ≤α then set vca=σ, and continue at vii
v. is α<vcaᵢₙₜ<β and Y<0 then set vca=β and continue at vii;
vi. is α<vcaᵢₙₜ<β and Y>0 then set vca=ξ;
vii. continue with step d.

12: The method according to claim 9, where the vector component angle, the vca, test c3) at least comprises the steps below where
$${vca}_{int} = {tan}^{- 1} \frac{Y}{X} :$$
to carry out one or more of the eight tests:
i. is γ≤vcaᵢₙₜ<α and Y<0 and X>0 then set vca=δ and continue at ix;
ii. is γ≤vcaᵢₙₜ<α and Y>0 and X<0 then set vca=κ, and continue at ix;
iii. is −α≤vcaᵢₙₜ<γ and Y>0 and X>0 then set vca=α, and continue at ix;
iv. is −α≤vcaᵢₙₜ<γ and Y<0 and X<0 then set vca=σ and continue at ix;
v. is α≤vcaᵢₙₜ<β and Y<0 then set vca=β and continue at ix;
vi. is α≤vcaᵢₙₜ<β and Y>0 then set vca=ξ and continue at ix;
vii. is −β<vcaᵢₙₜ<α and Y<0 then set vca=β and continue at ix;
viii. is −β<vcaᵢₙₜ<α and Y>0 then set vca=ξ;
ix. continue with step d in claim 1.

13: The method according to claim 1, where step e) at least comprises:
e1) testing if input parameter is a tap or press, if the input is press then an intermediate helpline is drawn,
e2) drawing a vector line from beginning of first helpline to end of a second helpline, and continue to wait for input parameters.

14: A CNC-parameter generating system in an isometric projection environment for the control and processing of tubes by at least one CNC-tube bending machine at least comprising:
a) a first operator in operable communication with a portable device), the portable device) comprises:
a1) an input unit;
a2) a software program for CNC-parameter generation in operable communication with the input device;
a3) a display unit in operable communication with the software program configured to display parameters generated by the software program on an isometric pattern including;
b) a communication interface facilitating communication between the portable device and at least a first computer, and
c) a communication interface facilitating communication between the first computer and at least a first CNC tube bending machine.

15: The CNC-parameter generating system according to claim 14 at least further comprising:
d) a second computer in operable communication with the portable device, the second computer being configured to compile tube bending parameters from the portable device into a format independent of the software program.

16: The CNC-parameter generating system according to claim 15 at least further comprising:
e) a tubing spool for loading into the CNC tube bending machine.
